(19) United States
(12) Patent Application Publication
(10) Pub. No.: US 2012/0248662 A1
(43) Pub. Date: Oct. 4, 2012

(54) MULTI-SHEET THERMOFORMING PROCESS

(76) Inventors: Christopher S. Klem, Saint Meinrad, IN (US); Brent Buschkoetter, Jasper, IN (US); Jay A. Kerkhoff, Velpen, IN (US)

(21) Appl. No.: 13/467,326

(22) Filed: May 9, 2012

Related U.S. Application Data
(63) Continuation of application No. 13/351,604, filed on Jan. 17, 2012.
(60) Provisional application No. 61/434,451, filed on Jan. 20, 2011.
(60) Provisional application No. 61/487,818, filed on May 19, 2011.

(51) Int. Cl. B29C 49/60; B29C 49/22

(52) U.S. Cl. 264/545; 425/503; 264/526

(57) ABSTRACT

Disclosed is a thermoforming mold that defines a surface of a thermoformed part, a cavity recess that defines part of the interior space of the thermoformed part, a bond flange ridge, a vent recess and a chamber recess in an offal region outside of the surface of the thermoformed part, where the chamber recess, the vent recess and the cavity recess collectively define a continuous recess and where the part does not extend substantially beyond the bond flange ridge. Also disclosed is a manufacturing method including molding a first and second plastic sheet to thermoforming molds, impressing the first and second plastic sheets together between the thermoforming molds to define the part, a seam, a vent and a chamber then inserting a blow needle into the chamber and using that blow needle to move a fluid through the interior space of the part through the vent and then removing the offal and the chamber from the part. Also disclosed is a thermoformed part manufactured using the mold and method described above.

### CROSS-REFERENCE TO RELATED APPLICATIONS

This application is a continuation-in-part of U.S. application Ser. No. 13/351,604, filed on Jan. 17, 2012. Application Ser. No. 13/351,604 claims the benefit of provisional Application No. 61/434,451, filed on Jan. 20, 2011. This application claims the benefit of U.S. Provisional Application No. 61/487,818 filed on May 19, 2011, which is hereby incorporated by reference.

### BACKGROUND

Thermoforming is a manufacturing process where a plastic sheet is heated above its glass transition temperature, reformed into a desired shape in a mold, cooled below the glass transition temperature, removed from the mold and then trimmed to create a desired product. Twin sheet thermoforming expands on this process by bonding two separately thermoformed sheets together prior to cooling below the glass transition temperature to create more complex and/or thicker products.

During thermoforming, the edges of the plastic sheet are generally restrained from moving while the inner portion of the sheet is stretched and reshaped by the mold, sometimes with a differential pressure (e.g. negative vacuum pressure on the mold side of the sheet and/or positive pressure on the opposite side) pushing the sheet against the mold. This leaves excess material around the periphery of the molded part that is generally removed to create the final desired product. This excess material is known as offal. Offal removal can be accomplished by placing the molded product, including offal, in a jig configured to secure the product while the offal is removed by CNC cutting or machining.

### BRIEF DESCRIPTION OF THE DRAWINGS

FIG. 1 is a perspective view of a toolbox lid.

FIG. 2 is a top view of the FIG. 1 toolbox lid.

FIG. 3 is a back side elevational view of the FIG. 1 toolbox lid.

FIG. 4 is a bottom plan view of the FIG. 1 toolbox lid.

FIG. 5 is a front elevational view of the FIG. 1 toolbox lid.

FIG. 6 is a right side elevational view of the FIG. 1 toolbox lid.

FIG. 7 is a top plan view of the FIG. 1 toolbox lid in an intermediate state of manufacture prior to removing the molding offal.

FIG. 8 is a top plan view of a top lid mold used to manufacture the FIG. 1 lid.

FIG. 9 is a top plan view of a bottom mold used to manufacture the FIG. 1 lid.

FIG. 10 is a cross-sectional view of the FIGS. 8-9 molds taken along line 10-10.

FIG. 11 is a cross-sectional view of the FIGS. 8-9 molds taken along line 11-11.

FIG. 12 is a process diagram detailing a method of manufacturing a thermoformed part.

FIG. 13 is a perspective view of a tray.

FIG. 14 is a top plan view of the FIG. 13 tray.

FIG. 15 is a front side elevational view of the FIG. 13 tray.

FIG. 16 is a bottom plan view of the FIG. 13 tray.

FIG. 17 is a left side elevational view of the FIG. 13 tray.

FIG. 18 is a perspective view of the FIG. 13 tray in an intermediate state of manufacture prior to removing the molding offal.

FIG. 19 is a perspective view of a top mold used to manufacture the FIG. 13 tray.

FIG. 20 is a top elevational view of the FIG. 19 top mold.

FIG. 21 is a front elevational view of a wall segment.

FIG. 22 is a front side elevational view of the FIG. 21 wall segment.

FIG. 23 is a left side elevational view of the FIG. 21 wall segment.

FIG. 24 is a perspective view of a mold half used to manufacture the FIG. 21 wall segment.

FIG. 25 is a front elevational view of a sectional door panel segment.

FIG. 26 is a left side elevational view of the FIG. 25 panel segment.

FIG. 27 is an end view of the FIG. 25 panel segment.

FIG. 28 is a bottom plan view of the FIG. 25 panel segment.

FIG. 29 is an exploded view of FIG. 28 taken in section line 29.

FIG. 30 is a partial view of the FIG. 25 panel segment in an intermediate state of manufacture prior to removing the molding offal.

### DETAILED DESCRIPTION

Reference will now be made to certain embodiments and specific language will be used to describe the same. It will nevertheless be understood that no limitation of the scope of this disclosure and the claims are thereby intended, such alterations, further modifications and further applications of the principles described herein being contemplated as would normally occur to one skilled in the art to which this disclosure relates. In several figures, where there are the same or similar elements, those elements are designated with the same or similar reference numerals.

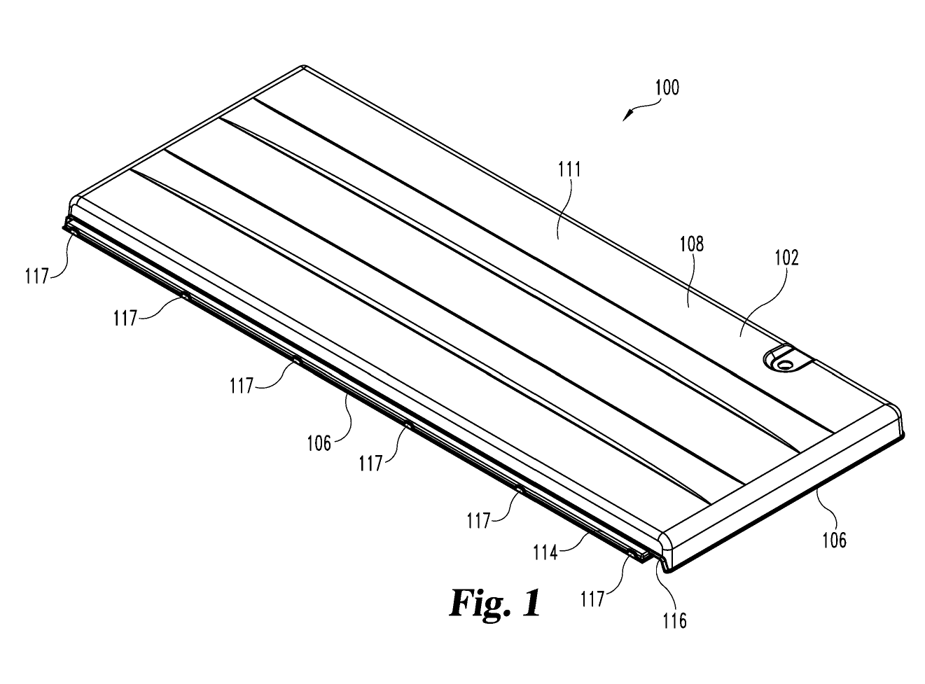

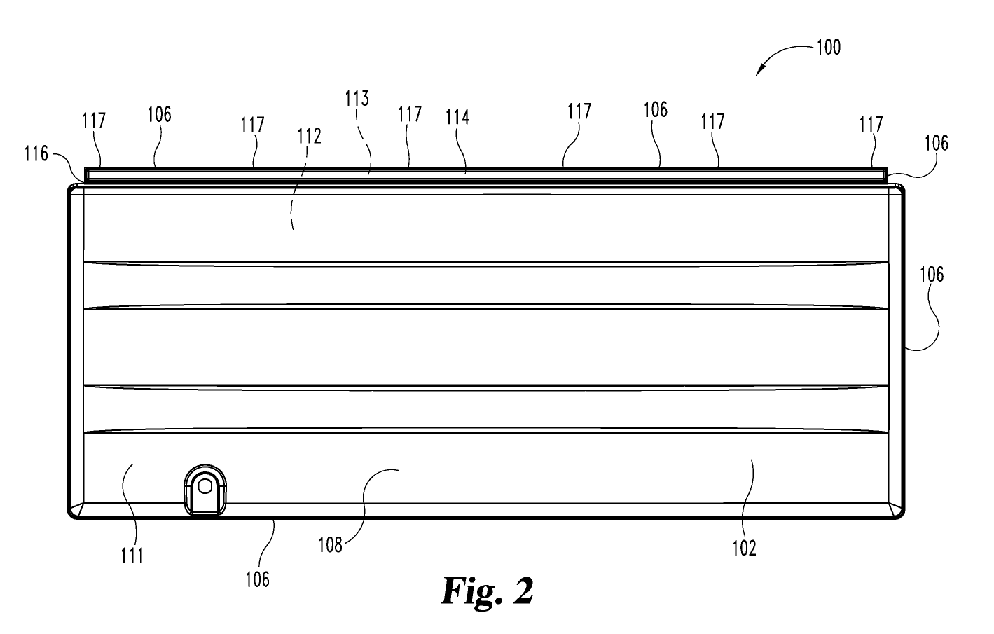

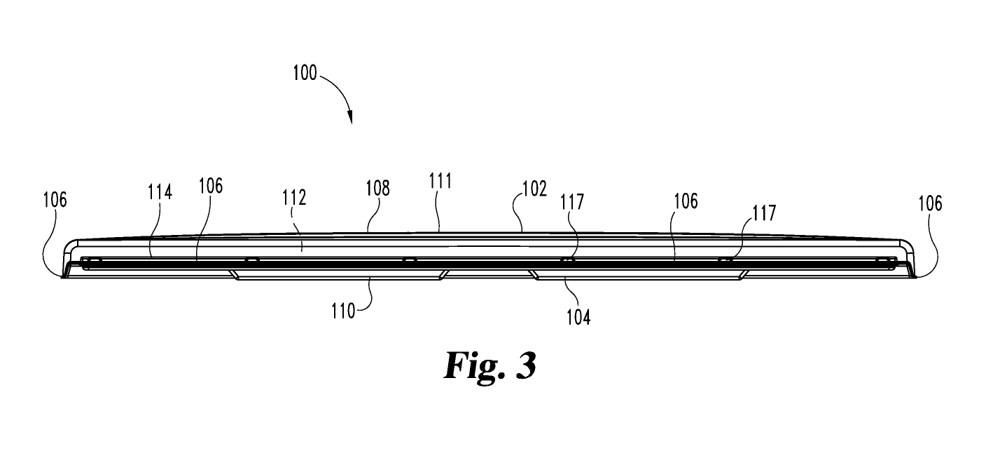

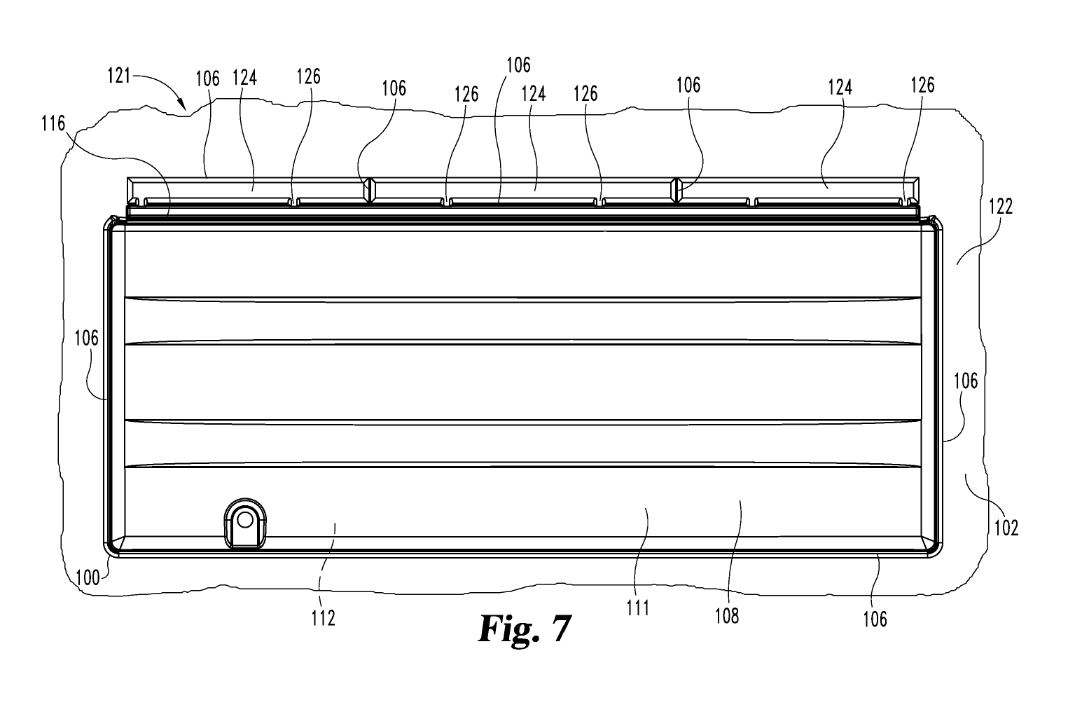

Referring to FIGS. 1-6, lid 100 is illustrated. Lid 100 is a toolbox lid for a truck toolbox. Lid 100 is thermoformed from plastic sheets 102 and 104 bonded together along bond flange 106. Lid 100 includes top surface 108, bottom surface 110, body 111, tab 114 which is separated from body 111 by living hinge 116. Body 111 has an internal cavity 112 and tab 114 has internal cavity 113. Internal cavities 112 and 113 represent the space between sheets 102 and 104 when they are thermoformed together. Tab 114 also includes a plurality of vents 117. As discussed in greater detail below, vents 117 are molded structures that extend into the offal area (removed in FIGS. 1-6, shown in FIG. 7) to vent internal cavity 113.

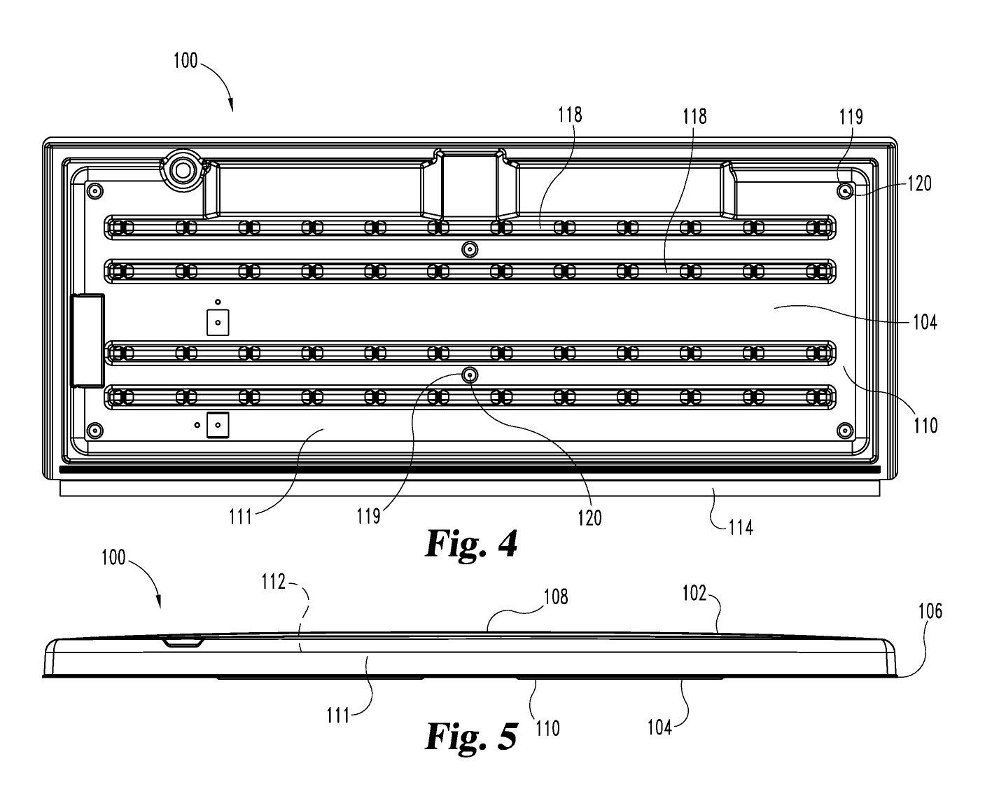

As best illustrated in FIG. 4, bottom surface 110 includes a plurality of ribs 118 that are optionally included for stiffness and strength. Ribs 118 may provide web structures across bottom surface 110 that may serve to increase the overall strength and stiffness of bottom surface 110 and body 111.

Also illustrated in FIG. 4 are a plurality of blow needle recesses 119 and holes 120. Holes 120 depict the hole left when a blow needle is extended through plastic sheet 104 during a thermoforming process to vent and/or move a vent transfer fluid through internal cavity 112.

Referring now to FIG. 7, lid 100 is illustrated in an intermediate manufacturing condition prior to removing the molding offal. Unfinished lid 121 includes offal 122, chamber 124 and vents 126. Chamber 124 is defined in the offal region of plastic sheets 102 and 104 and is bound by bond flange 106. Vent 126 is also defined by plastic sheets 102 and 104. Vent 126 connects the interior space of chamber 124 with internal cavity 113 in tab 114. Chamber 124 is configured and arranged to receive one or more blow needles during the molding process. The blow needles can then be used to vent internal cavity 113 and/or move a vent transfer fluid, such as air, through vents 126 and internal cavity 113 to aide in cooling plastic sheets 102 and 104 defining tab 114.

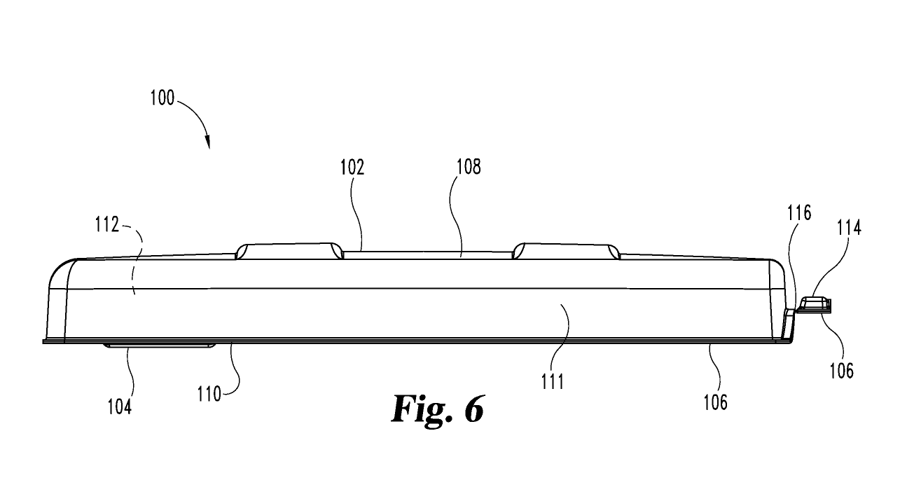

As best shown in FIG. 6, tab 114 is dimensionally configured too small to reliably insert blow needles into internal cavity 113. Chamber 124 provides a structure that is sufficiently large to receive a blow needle and vents 126 fluidly connect the two. In one embodiment, an individual chamber 124 can receive blow needles proximate to each vent 126. In one embodiment, some blow needles can provide a supply of heat transfer fluid while the remaining blow needles can withdraw the heat transfer fluid to provide a flow through internal cavity 113. In other embodiments, the central chamber 124 illustrated in FIG. 7 could receive one set of blow needles that supply heat transfer fluid while the two chambers 124 positioned on the outside could receive blow needles to withdraw the heat transfer fluid to provide a flow through internal cavity 113.

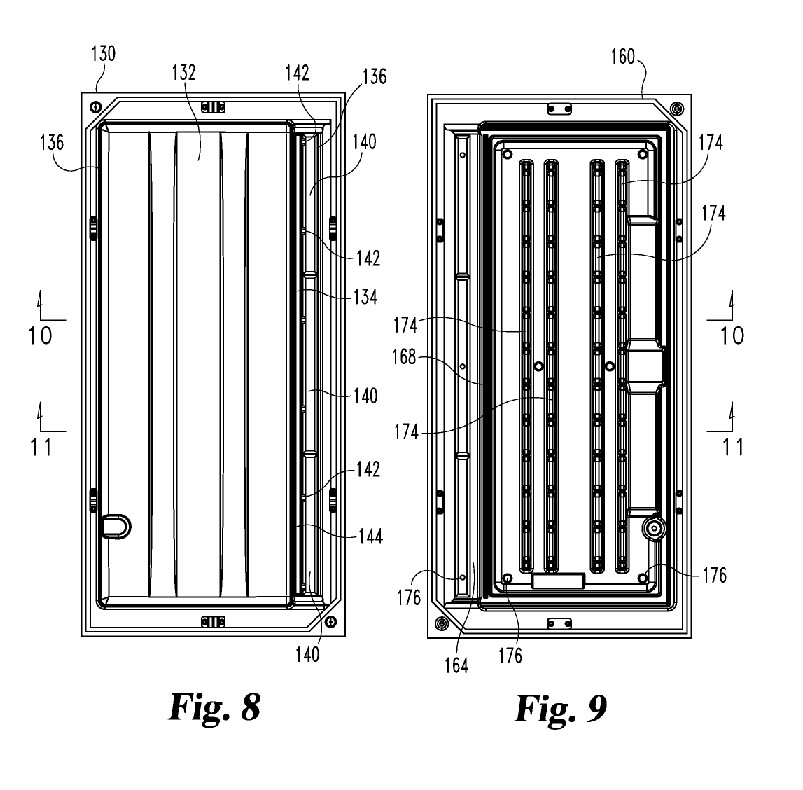

Referring now to FIGS. 8-11, top mold 130 and bottom mold 160 are shown. Top mold 130 and bottom mold 160 are used to thermoform lid 100 (and unfinished lid 121). Note that “top” and “bottom” are used for distinguishing purposes only. Molds 130 and 160 may be arranged in any manner desired. Top mold 130 includes surface 132, tab recess 134, bond flange ridge 136, offal region 138, chamber recess 140, vent recess 142 and living hinge ridge 144. Offal region 138 generally includes the area of the mold outside of the finished lid. This may include portions defined by bond flange ridge 136.

Bottom mold 160 includes surface 162, surface 164, bond flange ridge 166, living hinge surface 168, offal region 170, chamber recess 172, rib protuberances 174 and blow needle protuberances 176. While not illustrated, bottom mold 160 also includes the capacity to pass one or more blow needles through bottom mold 160 to pass through plastic sheet 104. Once again, offal region 170 includes the area of the mold outside of the finished lid. This may include portions defined by bond flange ridge 136.

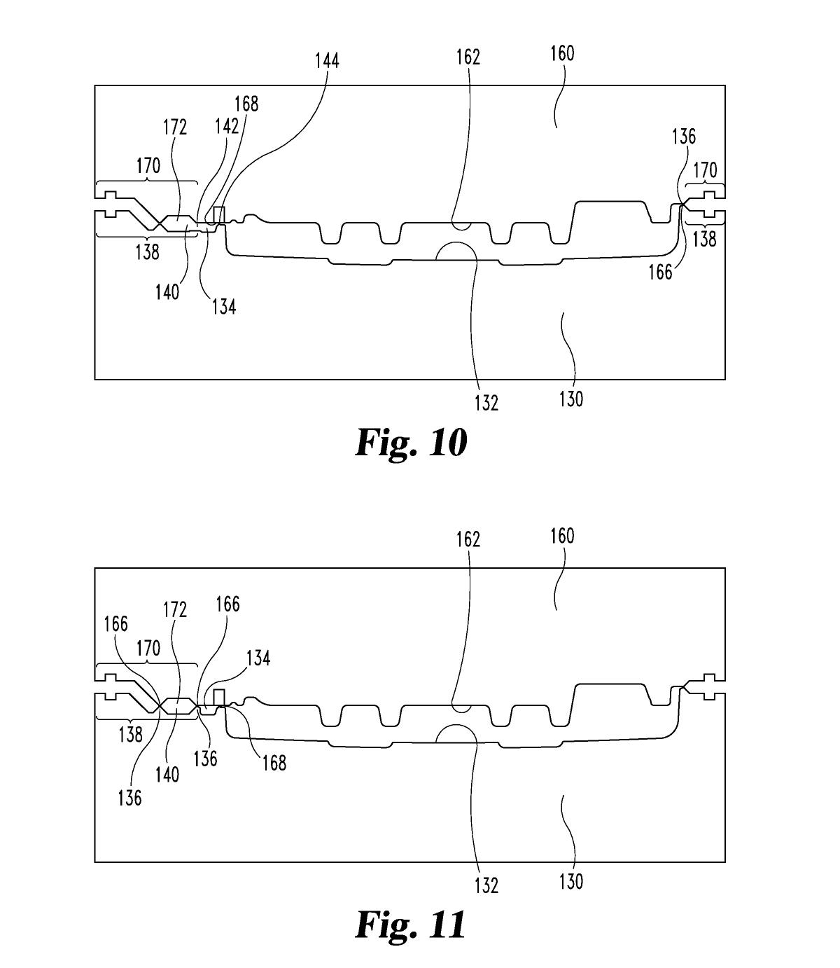

During thermoforming plastic sheet 102 is molded to top mold 130 and plastic sheet 104 is molded to bottom mold 160. Top mold 130 and bottom mold 160 are then brought together as shown in FIGS. 10-11 to define unfinished lid 121. Sheets 102 and 104 are bonded together along bond flange 106 where sheets 102 and 104 are molded together between bond flange ridge 136 and 166. Top surface 108 is defined by surface 132 and bottom surface 110 is defined by surface 162. Living hinge 116 is molded between living hinge ridge 144 and living hinge surface 168. Vents 117 are defined by vent recess 142 and surface 164. Ribs 118 are defined by rib protuberances 174. Blow needle recesses 119 are defined by blow needle protuberances 176. Hole 120 is defined by the blow needles that pass through blow needle protuberances 176 and plastic sheet 104 during the thermoforming process.

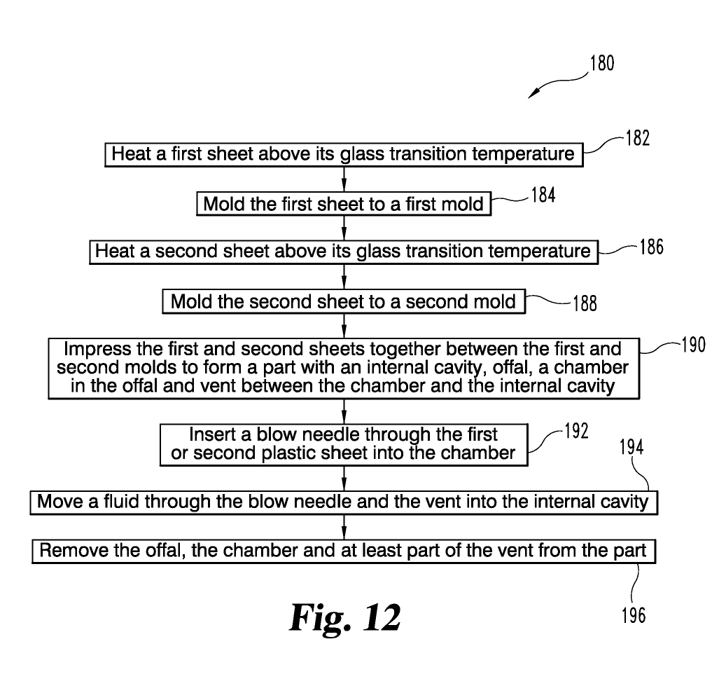

Referring now to FIG. 12, process 180 is illustrated. Process 180 details several process steps that can be used to thermoform lid 100 or any of the other parts disclosed herein. Please note that process 180 is not all inclusive and many additional steps would be apparent to a person of ordinary skill in the art. Steps described in process 180 may be used with a variety of different thermoforming methods including a multi-station thermoforming machine that includes at least four stations that moves plastic sheets between the multiple stations by a set of clamp frames that rotate between the positions. The stations may include a load/unload station, a first preheat oven, a second final heat oven and a molding position where molding and thermoforming takes place.

Process 180 is related to making a single unit. It should be understood that this process is intended to be used in a continuous process where actions repeatedly occur facilitating continuous production of manufacturing parts. In any event, process 180 is intended to be adaptable by a person skilled in the art to any type of thermoforming machine or equipment. They are not explicitly described. For example, thermoforming machines that clamp two sheets in a single clamp frame is known in the art.

Process 180 begins with step 182 where a first plastic sheet (for example plastic sheet 102) is heated above its glass transition temperature. This is followed by step 184 where the first sheet is molded with a first mold (for example top mold 130). Next in step 186 a second sheet (for example plastic sheet 104) is heated above its glass transition temperature and in step 188 the second sheet is molded to a second mold (for example bottom mold 160).

Next in step 190, the first and second sheets are pressed together between the first and second molds to form a part with an internal cavity offal, a chamber in the offal and a vent between the chamber and the internal cavity. In step 192, a blow needle is inserted through either the first or second plastic sheet into the chamber and in step 194, a fluid (for example air) is moved through the blow needle and vent into the internal cavity between the first and second sheets. Finally, in step 196 the offal is removed (for example by machining and/or with die cuts on some portions) thereby removing the chamber and at least part of the vent from the manufactured part.

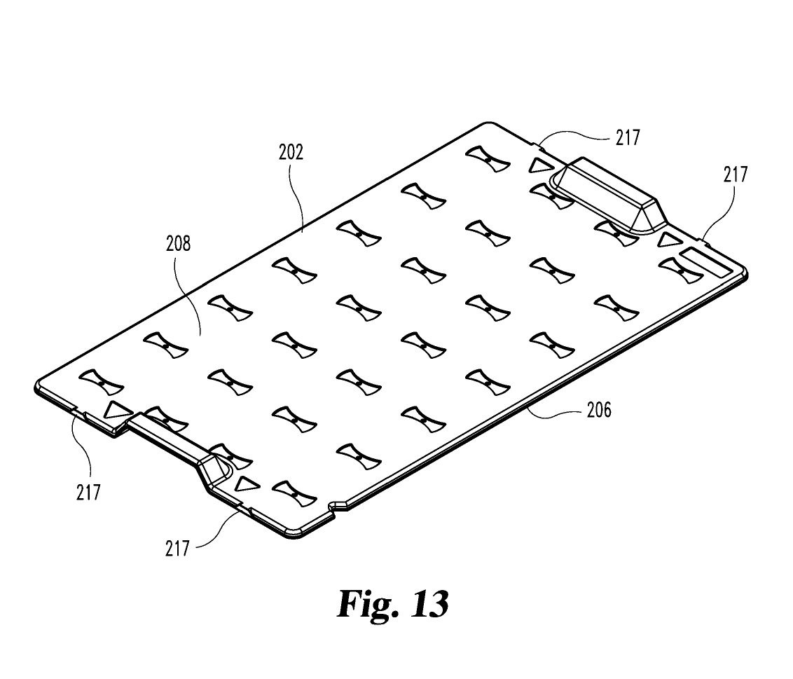

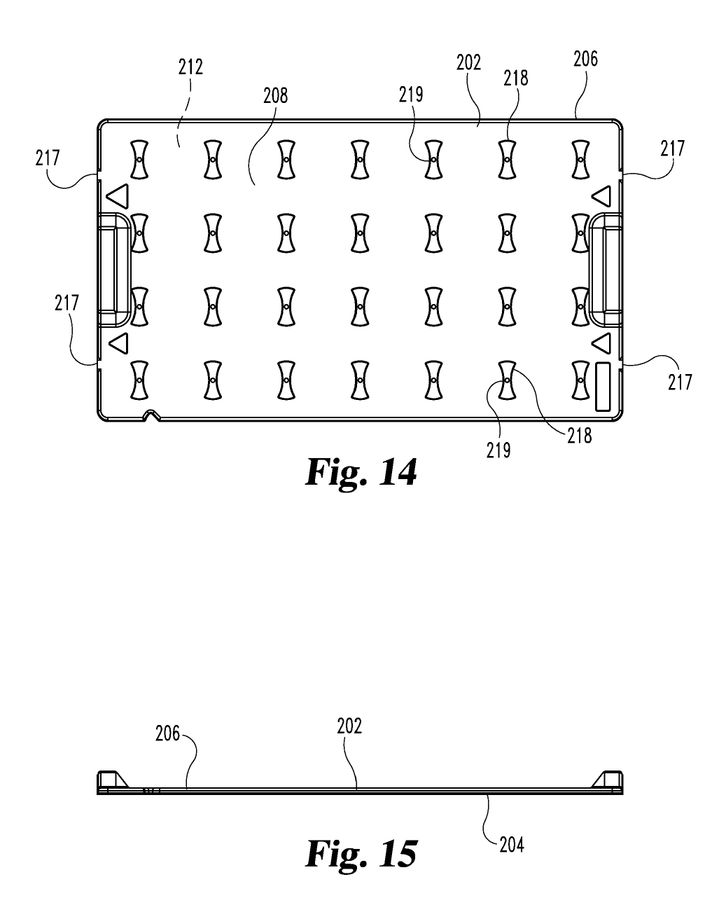

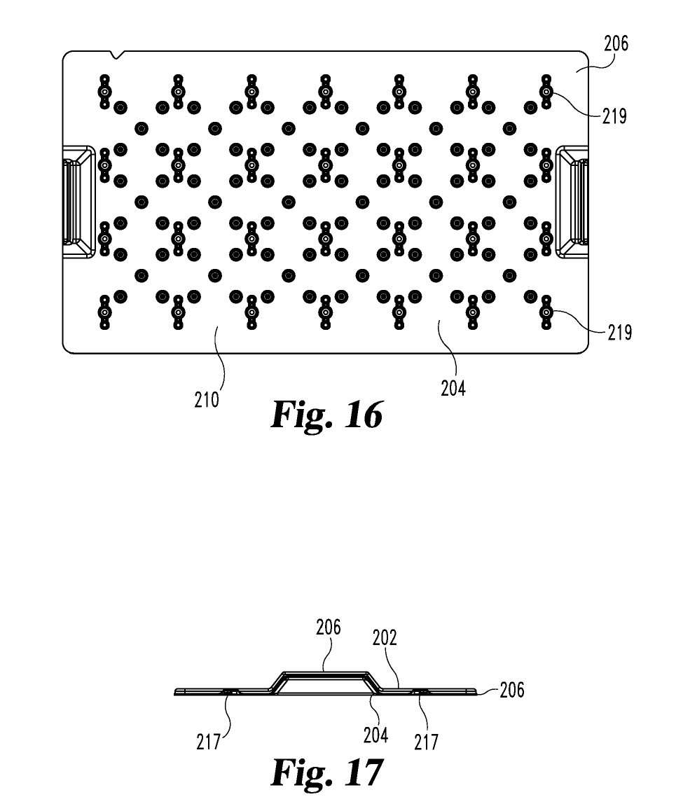

Referring now to FIGS. 13-17, tray 200 is illustrated. Tray 200 is a sample tray for processing groups of samples in appropriate equipment. Tray 200 is thermoformed from plastic sheets 202 and 204 bonded together along bond flange 206. Tray 200 includes top surface 208, bottom surface 210, internal cavity 212. Internal cavity 212 is the space between sheets 202 and 204 when they are thermoformed together. Tray 200 also includes a plurality of vents 217 which extend into the offal area. Vents 217 are fluidly connected to internal cavity 212.

Tray 200 also includes a plurality of recesses 218 each including through hole 219. Recesses 218 are configured and arranged to hold an individual sample in position on tray 200. Tray 200 is configured to hold 28 separate samples for batch processing in appropriate equipment.

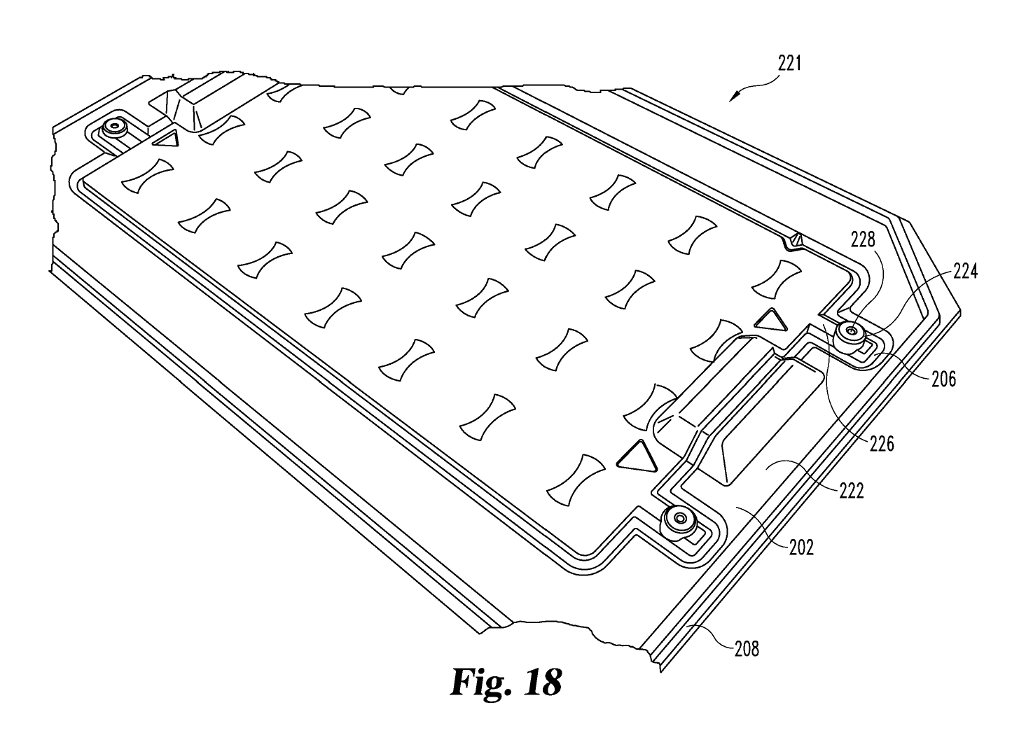

Referring now to FIG. 18, the tray 200 is illustrated in an intermediate manufacturing condition prior to removing the molding offal. Unfinished tray 221 includes offal 222, chamber 224 and vents 226. Chamber 224 is defined in the offal region of plastic sheets 202 and 204 and is bound by bond flange 206. Vent 226 is also defined by plastic sheets 202 and 204 and is bound by bond flange 206. Vent 226 fluidly connects internal cavity 212 with the internal space of chamber 224. Chamber 224 is configured and arranged to receive a blow needle in blow needle hole 228 during the molding process. Blow needles can then be used to vent internal cavity 212 by moving heat transfer fluid, such as air, through vents 226 to aide in cooling plastic sheets 202 and 204 defining tray 200.

As best seen in FIGS. 15 and 17, tray 200 is configured with sheets 202 and 204 positioned too close together to reliably insert blow needles into internal cavity 212. In addition, in the application, residual blow needle holes may provide a source for unwanted contamination. Chambers 224 and vents 226 provide a structure that is sufficiently large to receive a blow needle while vents 226 fluidly connect chamber 224 and internal cavity 212.

After molding tray 200 is finished by cutting or machining off offal 222 including all of chamber 224 and most of vent 226 leaving vent 217 in the side walls of tray 200. Vents 217 are located in the side of tray 200, away from recesses 218.

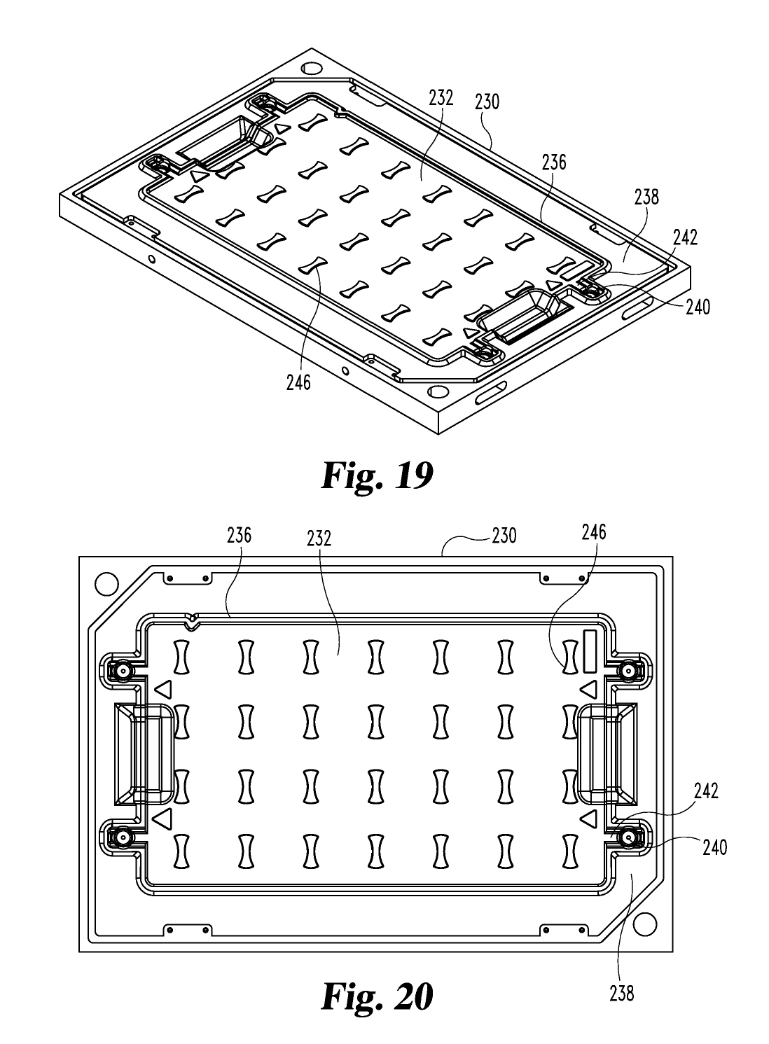

Referring now to FIGS. 19-20, mold 230 is illustrated. Mold 230 is the top mold used to form tray 200. Mold 230 includes surface 232, bond flange ridge 236, offal region 238, chamber recesses 240, vent recesses 242 and protrusions 246. Surface 232 defines top surface 208, bond flange ridge 236 forms half the clamp surfaces that form bond flange 206. Offal region 238 generally includes the area of the mold outside of tray 200. Chamber recesses 240 define chambers 224, vent recesses 242 define vents 226 and protrusions 246 define recesses 218 in tray 200.

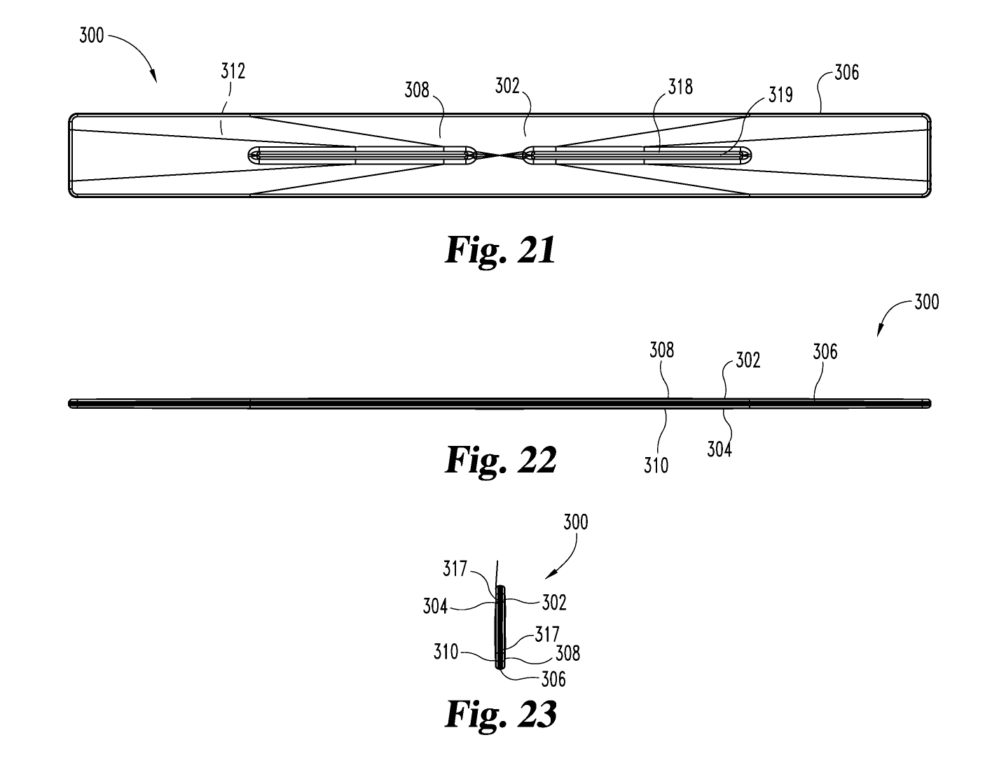

Referring now to FIGS. 21-23, wall segment 300 is illustrated. Wall segment 300 is configured as a portion of a bathroom stall. In particular, wall segment 300 is a vertical support member for attaching a longer wall segment to the floor. Wall segment 300 can also be used to attach a door or the catch for a door to the bathroom stall.

In any event, wall segment 300 is thermoformed from plastic sheets 302 and 304, bonded together along bond flange 306. Wall segment 300 includes front surface 308 and back surface 310 defining internal cavity 312. Internal cavity 312 represents the space between sheets 302 and 304 when they are thermoformed together. Wall segment 300 includes vents 317, mounting recess 318 and hole 319. Mounting recess 318 and hole 319 are used to couple the longer wall segment to wall segment 300 with wall segment 300 crossing the end of the longer wall segment in a T-shaped configuration.

While sheets 302 and 304 are generally positioned far enough apart to permit the use of blow needles through either front or back surface 308 or 310 to vent internal cavity 312, the intended application of wall segment 300 required substantially unbroken front and back surface 308 and 310 for hygiene. In the illustrated configuration, vents 317 are located on the top and bottom surfaces of wall segment 300, where they can be substantially covered by framing materials used in the final bathroom stall.

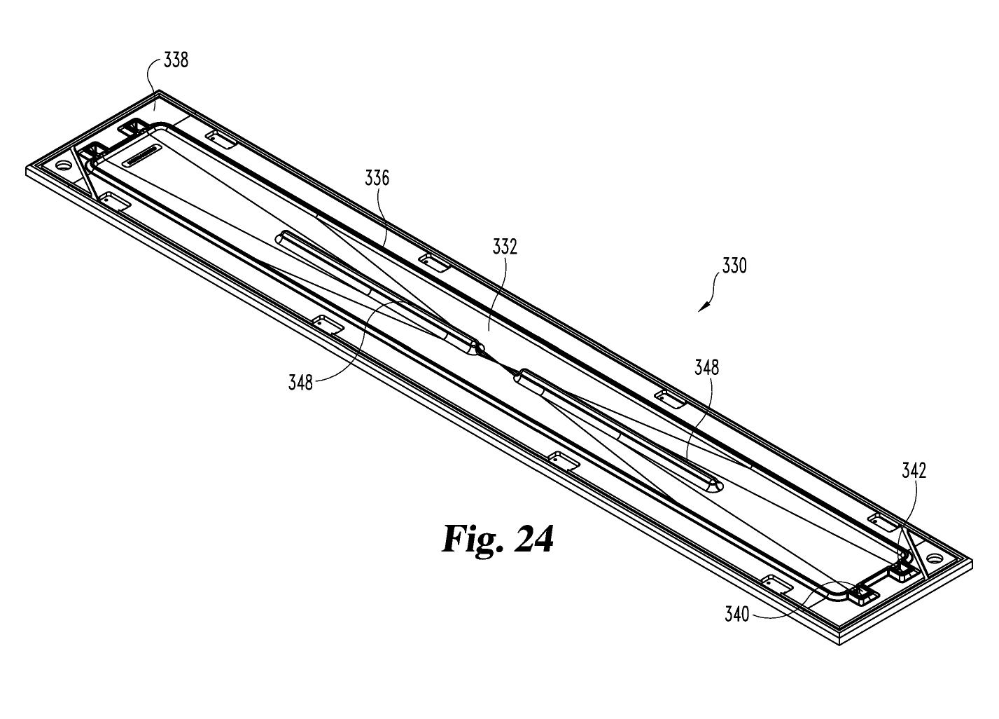

Referring now to FIG. 24, mold 330 is illustrated. Mold 330 is a top mold used to form wall segment 300. Mold 330 includes surface 332, bond flange ridge 336, offal region 338, chamber recesses 340, vent recesses 342, and protrusions 348. Surface 332 defines front surface 308. Bond flange ridge 336 shapes half of the surfaces that define and form bond flange 306. Offal region 338 generally includes the area of the mold outside of wall segment 300 and includes portions of bond flange 306. Chamber recesses 340 define part of chamber structures similar to chamber 224 described above in the offal area of plastic sheets 302 and 304. Vent recesses 342 define parts of vents that fluidly connect the chamber in the offal area with internal cavity 312 and protrusions 348 define mounting recesses 318 in wall segment 300.

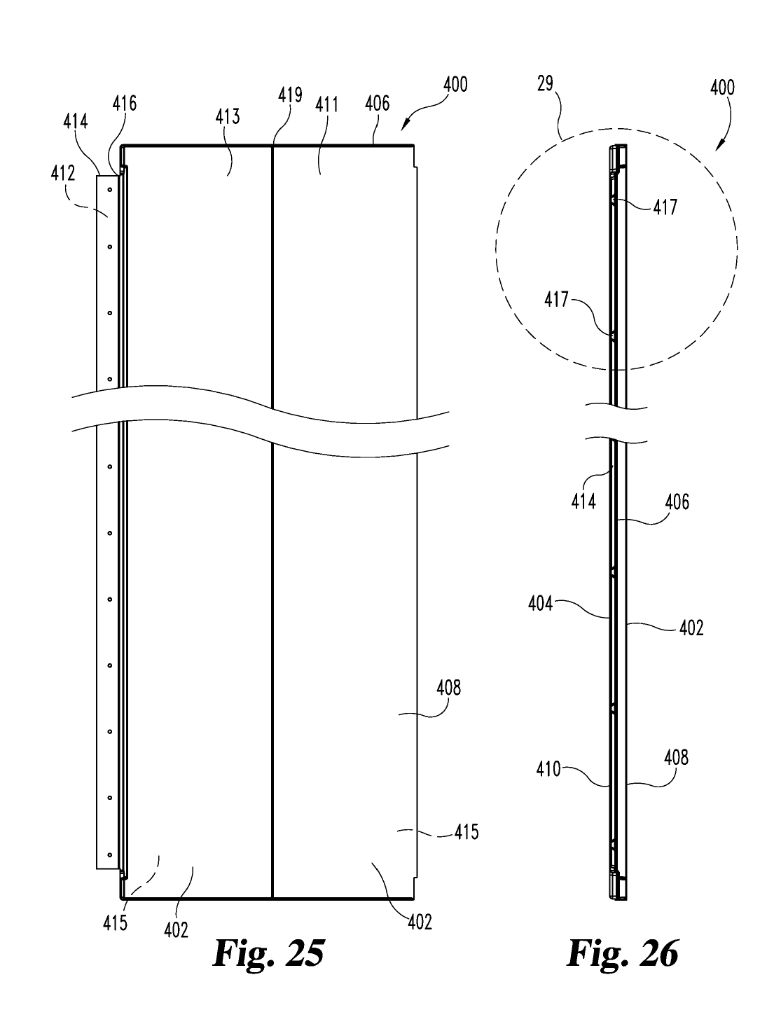

Referring now to FIGS. 25-29, panel door section 400 is illustrated. Panel door section 400 is configured and arranged to be assembled in a panel door with a plurality of other similar panel door sections. In this context, a sectional door refers to a door that includes separate hinge panels that slide along a track or guide to open and close a door. Common examples include overhead garage doors and overhead vehicle trailer doors. Panel door section 400 is configured as a vehicle trailer door but similar panel door section 400 can be used for other desired door applications.

Panel door section 400 includes plastic sheets 402 and 404 bonded together along bond flange 406. Panel door section 400 includes outside surface 408 and inside surface 410. Panel door section 400 includes panel section 411 and panel section 413 separated by living hinge 419. Panel door section 400 also includes tab 414 separated from panel section 413 by living hinge 416. Panel sections 411 and 413 define internal cavity 412 while tab 414 defines internal cavity 415. Tab 414 includes a plurality of vents 417. As discussed above, similar to the vents discussed above vents 417 are molded structures that extend into the offal area to vent internal cavity 415.

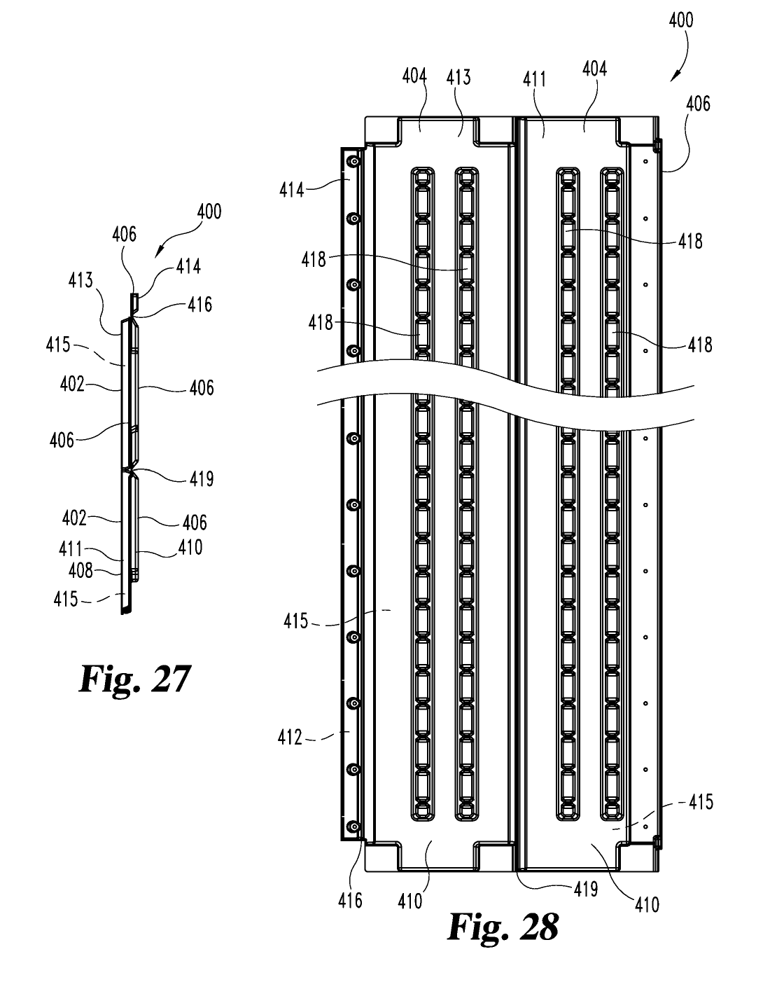

As best shown in FIG. 27, tab 414 is dimensionally configured too small to reliably insert blow needles into internal cavity 415. Chambers 424 provides structures that are sufficiently large to receive a standard blow needle and vents 426 fluidly connect chambers 424 to internal cavity 415.

Inside surface 410 on panel sections 411 and 413 include plurality of ribs 418 that are optionally included for stiffness and strength. Ribs 418 may provide web structures along inside surface 410 that serve to increase the overall strength and stiffness of panel sections 411 and 413.

Referring to FIG. 30, a partial bottom view of panel door section 400 is illustrated showing panel door section 400 in a unfinished state as it may appear after molding but before the removal of the offal. Unfinished panel door section 421 includes offal 422, bond flange 406, chamber 424, vent 426, blow needle hole 428 and die cut score line 430. Offal 422 includes the portions of plastic sheets 402 and 404 that are gripped by clamp frames during thermoforming. This region of plastic provides a reservoir of material for draw down when sheets 402 and 404 are molded. Offal 422 includes most of bond flange 406 that defines the outer periphery of panel door section 400.

Vent 426 and chamber 424 are molded structures that extend into offal 422 to provide venting to internal cavity 415. Chamber 424 is configured to receive a blow needle during thermoforming. Vent 426 provides an internal passageway between chamber 424 and internal cavity 415. Blow needle hole 428 depicts the hole left from the blow needle extending through plastic sheet 404 during thermoforming.

Also illustrated in FIG. 30 is die cut score line 430 along the bottom of tab 414 and living hinge 416. Die cut score line 430 is located in bond flange 406 and may represent either a thinned portion of bond flange 406 or a through cut. Die cut score line 430 is defined by the mold sections used to thermoform panel door section 400. Die cut score line 430 can be used in the manufacturing of panel door section 400 to provide early release of tab 414 to allow early movement and flexation of living hinge 416.

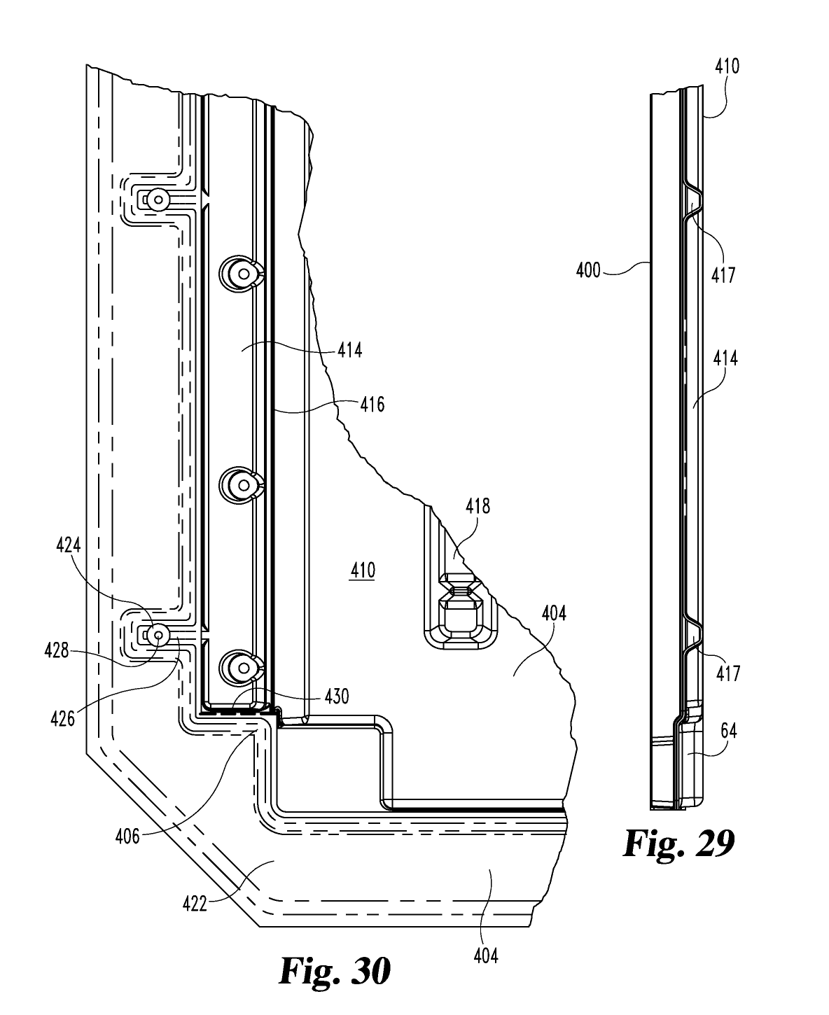

Referring to FIG. 29, a partial side view of panel door section 400 is illustrated mirroring the portion of unfinished panel door section 421 shown in FIG. 30. As illustrated in FIG. 29, machining or cutting along bond flange 406 removes vents 426 and leaves vents 417 through the side wall of tab 414.

This disclosure serves to illustrate and describe the claimed invention to aid in the interpretation of the claims. However, this disclosure is not restrictive in character because not every embodiment covered by the claims is necessarily illustrated and described. All changes and modifications that come within the scope of the claims are desired to be protected, not just those embodiments explicitly described.

We claim:

1. A method of manufacturing a part, the method comprising:
molding a first plastic sheet with a first mold, wherein the first mold defines a first surface, a bond flange ridge, a first vent recess, a first offal region outside of the first surface and a first chamber recess in the first offal region, wherein the first vent recess connects the first chamber recess and the first surface;
molding a second plastic sheet with a second mold, wherein the second mold defines a second surface;
impressing the first plastic sheet and the second plastic sheet together between the first and second molds thereby forming the part, a seam, a first vent and a first chamber, wherein the first vent is shaped by the first vent recess and the second mold, wherein the first chamber is shaped by the first chamber recess and the second mold, wherein the part is shaped by the first and second surfaces and wherein the seam is shaped by the bond flange ridge and the second mold;
inserting a first blow needle through either the first or second plastic sheet into the first chamber;
moving a fluid through the first blow needle then through the vent into an interior space of the part; and
removing offal and the first chamber from the part.

2. The method of claim 1, further comprising heating the first and second plastic sheets above their glass transition temperatures.

3. The method of claim 1, wherein the first mold defines a second vent recess and a second chamber recess and wherein the part includes a second vent shaped by the second vent recess and the second mold and a second chamber shaped by the second chamber recess and the second mold and wherein the method further comprises:
inserting a second blow needle through either the first or second plastic sheet into the second chamber;
injecting the fluid into the interior space through the first blow needle and the first vent; and
extracting the fluid from the interior space through the second vent and the second blow needle.

4. The method of claim 1, wherein the majority of the first and second surfaces are unsuitable to accept the first blow needle.

5. The method of claim 1, wherein a portion of the first and second surfaces are unsuitable to accept the first blow needle.

6. The method of claim 5, wherein the first vent recess is located proximate to the portion of the first and second surfaces unsuitable to accept the first blow needle.

7. The method of claim 3, further comprising removing the second chamber from the part.

8. An apparatus comprising:
a mold defining a surface of a part, a cavity recess defining the interior space of the part, a bond flange ridge, a vent recess and a chamber recess in an offal region outside of the surface, wherein the chamber recess, the vent recess and the cavity recess collectively define a continuous recess and wherein the part does not extend substantially beyond the bond flange ridge.

9. The apparatus of claim 8, wherein the majority of the surface is unsuitable to accept a blow needle configured to extend through a sheet of plastic molded by the mold.

10. The apparatus of claim 8, wherein a portion of the surface is unsuitable to accept a blow needle configured to extend through a sheet of plastic molded by the mold.

11. The apparatus of claim 10, wherein the first vent recess is located proximate to the portion of the surface unsuitable to accept the first blow needle.

12. The apparatus of claim 8, further comprising a blow needle arranged proximate to the chamber recess.

13. The apparatus of claim 11, further comprising a blow needle arranged proximate to the chamber recess.

14. An apparatus comprising:
a first and second sheet of plastic thermoformed together defining an outer surface of a part, an internal cavity of the part, a seam, a vent, offal and a chamber, wherein the chamber is located in the offal, wherein the chamber is constructed and arranged to receive a vent needle and wherein the chamber is fluidly connected to the internal cavity through the vent and wherein the outer surface does not extend substantially beyond the seam.

15. The apparatus of claim 14, wherein the majority of the outer surface is unsuitable to accept a blow needle.

16. The apparatus of claim 14, wherein a portion of the outer surface is unsuitable to accept a blow needle.

17. The apparatus of claim 16, wherein the first vent recess is located proximate to the portion of the outer surface unsuitable to accept the blow needle.

18. The apparatus of claim 14, wherein a portion of the internal cavity includes a cavity depth less than three centimeters.

19. The apparatus of claim 14, wherein the seam is constructed and arranged to be cut to separate the offal and the chamber from the part.

20. The apparatus of claim 19, wherein the vent is constructed and arranged to define an opening to the internal cavity in the part after the offal and the chamber is separated from the part.
